(19) United States
(12) Patent Application Publication
(10) Pub. No.: US 2015/0160750 A1
(43) Pub. Date: Jun. 11, 2015

(54) ELECTRONIC APPARATUS

(71) Applicant: Kabushiki Kaisha Toshiba, Tokyo (JP)

(72) Inventor: Johnsan Wu, Taipei Taiwan (TW)

(21) Appl. No.: 14/617,675

(22) Filed: Feb. 9, 2015

Related U.S. Application Data
(63) Continuation of application No. PCT/JP2013/073724, filed on Aug. 28, 2013.

(30) Foreign Application Priority Data
Oct. 25, 2012 (JP) 2012-235953

(51) Int. Cl. G06F 3/041; G06F 3/01

(52) U.S. Cl. CPC G06F 3/041; G06F 3/0414; G06F 3/016

(57) ABSTRACT

According to one embodiment, an electronic apparatus has a housing for an outer shell, and an input apparatus having an input unit exposed to an outer surface of the housing to be operated. The input apparatus has a pad, a circuit substrate, a switch and a support. The pad has the input unit on an obverse. The circuit substrate is attached on the reverse of the pad, and controls a signal input from the pad. The switch is attached to the reverse of the pad. The support holds the pad, and is jointed to the housing by arms which have spring elasticity for displacing the pad in a thickness direction.

### CROSS REFERENCE TO RELATED APPLICATIONS

This application is a Continuation Application of PCT Application No. PCT/JP2013/073724, filed Aug. 28, 2013 and based upon and claiming the benefit of priority from Japanese Patent Application No. 2012-235953, filed Oct. 25, 2012, the entire contents of all of which are incorporated herein by reference.

### FIELD

Embodiments described herein relate generally to an electronic apparatus which has a touch pad in an operating unit.

### BACKGROUND

An electronic apparatus such as a portable computer has a touch pad on a front side of a keyboard as a function corresponding to an input operation using a mouse. The touch pad is utilized by a user to sensuously operate a position of a cursor. In this case, the touch pad is mounted together with operation buttons to exert the same function as a mouse. Some computers have a control module which is referred to as a “touch click pad” in which a touch pad is movable and a switch of operation buttons is arranged below the touch pad.

By the way, a thinner and lighter electronic apparatus such as a portable computer is demanded. Hence, a control module as a part to be mounted in the electronic apparatus is also demanded to be thin without an exception. The touch click pad is assembled such that a plurality of parts such as a touch pad, a support which movably supports this touch pad, a switch which serves as operation buttons, a mounting base of this switch and a wiring connected to the touch pad and the switch overlap. Hence, when the number of parts is large, thickness dimension precision of each part and fabrication tolerance upon assembly of each part need to be taken into account. Further, the touch click pad needs to provide a stroke for allowing the switch to adequately operate, and a sense of clicking for notifying to the user that the switch is operated.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view of a portable computer which is an electronic apparatus according to a first embodiment;

FIG. 2 is an exploded perspective view illustrating a touch pad in FIG. 1 from diagonally above;

FIG. 3 is an exploded perspective view illustrating the touch pad in FIG. 2 from diagonally below;

FIG. 4 is a perspective view illustrating the assembled touch pad in FIG. 3 from below;

FIG. 5 is a cross-sectional view of the touch pad along a F5-F5 line in FIG. 4; and

FIG. 6 is a cross-sectional view of the touch pad along a F6-F6 in FIG. 4.

### DETAILED DESCRIPTION

Various embodiments will be described hereinafter with reference to the accompanying drawings.

An electronic apparatus according to an embodiment of the present invention has a housing as an outer shell, and an input apparatus having an input unit exposed to an outer surface of the housing to be operated. The input apparatus has a pad, a circuit substrate, a switch and a support. The pad forms the input unit. The circuit substrate is attached to the rear surface of the pad, and controls a signal inputted from the pad. The switch is attached to the reverse of the pad. The support holds the pad, and is jointed to the housing by arms which have spring elasticity for displacing the pad in a thickness direction.

According to the embodiment of the present invention, the electronic apparatus is provided which has a control module which requires a small number of parts and has good operability.

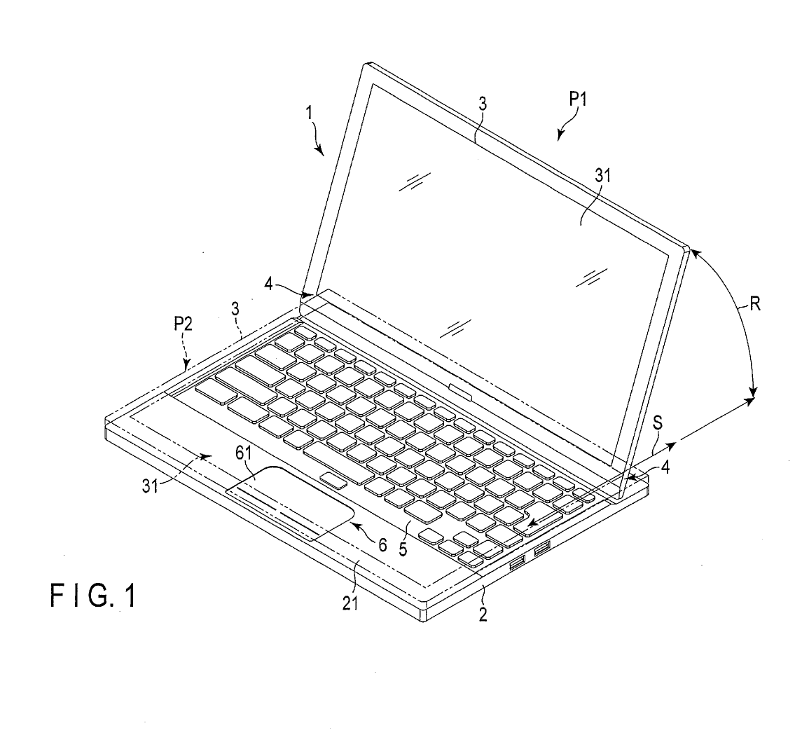

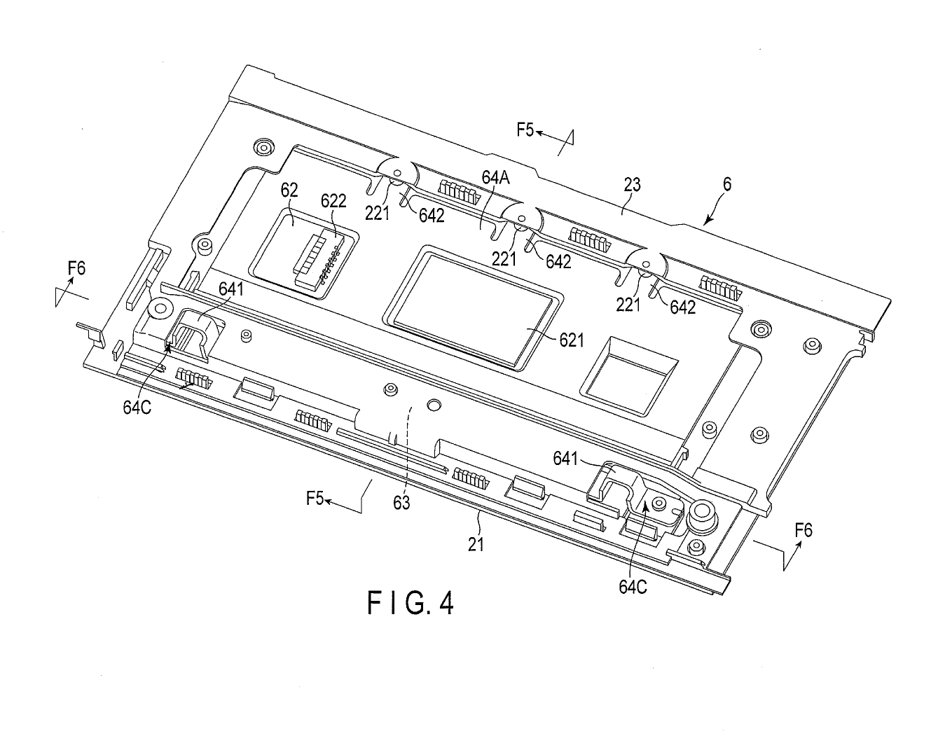

The electronic apparatus according to the embodiment of the present invention will be described using a portable computer 1 as an example with reference to FIGS. 1 to 6. The portable computer 1 illustrated in FIG. 1 has a housing 2 which accommodates a mother board, a display 3 which accommodates a display unit, and a hinge mechanism 4 which joints the housing 2 and the display 3.

This portable computer 1 is transformed to a first using style P1 illustrated in FIG. 1 in which the display 3 is placed upright with respect to the housing 2 and on the other side of a keyboard 5 arranged on the housing 2 using the hinge mechanism 4, and a second using style P2 in which the display 3 is overlaid on the housing 2 in a state where a display surface 31 is exposed. In the portable computer 1, an apparatus such as a touch sensor which can be directly operated by a user's finger and a digitizer which receives an input from a dedicated pen is mounted in the display 3 such that an input operation can be performed through the display surface 31 of the display 3 in the second using style. The second using style P2 is also referred to as a “tablet style”.

For ease of description, in this description, a side which faces a user upon the first using style P1 is defined as a “obverse” or a “front”, a side on which the hinge mechanism 4 is mounted a “reverse” or a “back”, sides seen from the user who operates the portable computer 1 a “right” and a “left”, a side of the housing 2 on which the input operation of the display 3 is performed a “obverce” or an “upper”, and a side opposite to the top a “reverce” or “lower”. Terms similar to these terms can also be used.

In addition, upon transformation from the second using style to the first using style P1, the display 3 is slid along the housing 2 toward a rear portion of the housing 2 at which the hinge mechanism 4 is arranged, and is placed upright as illustrated in FIG. 1. The hinge mechanism 4 has base portions, arms, rails, racks, pinions and a rod to enable this operation. The base portions are connected to corner portions of an obverse at a rear side of the housing 2. The arms are jointed to the base portions. The rails are attached in parallel to both left and right sides of the back surface of the display 3. The arms have sliders which fit to these rails. A pair of racks is disposed on the left and right sides of the back surface of the display 3 in parallel to the rails. The pinions are disposed near the base portions and at positions meeting the left and right racks. The rod joints a pair of pinions to synchronize rotation angles of the pinions. The above structure is adopted, so that the display 3 slides along an arrow S in FIG. 1 with respect to the housing 2, and turns as indicated by an arrow R. The racks and the pinions are provided, so that, when the display 3 is slid with respect to the housing 2, the display 3 moves in a plane without being twisted in this plane, and stably operates.

Outside the housing 2 which is exposed in the first using style P1, the portable computer 1 has the keyboard 5 and the touch pad 6 which are examples of input apparatuses. This portable computer 1 has the touch pad 6 which is spaced farther apart from the display 3 than the keyboard 5. Upon transformation from the second using style P2 to the first using style P1, the display 3 which is overlaid on the housing 2 is slid and moved along the upper surface of the housing 2 in a direction apart from the touch pad 6, and is turned by the hinge mechanism 4. Upon transformation from the first using style P1 to the second using style P2, an operation is performed to reverse this movement.

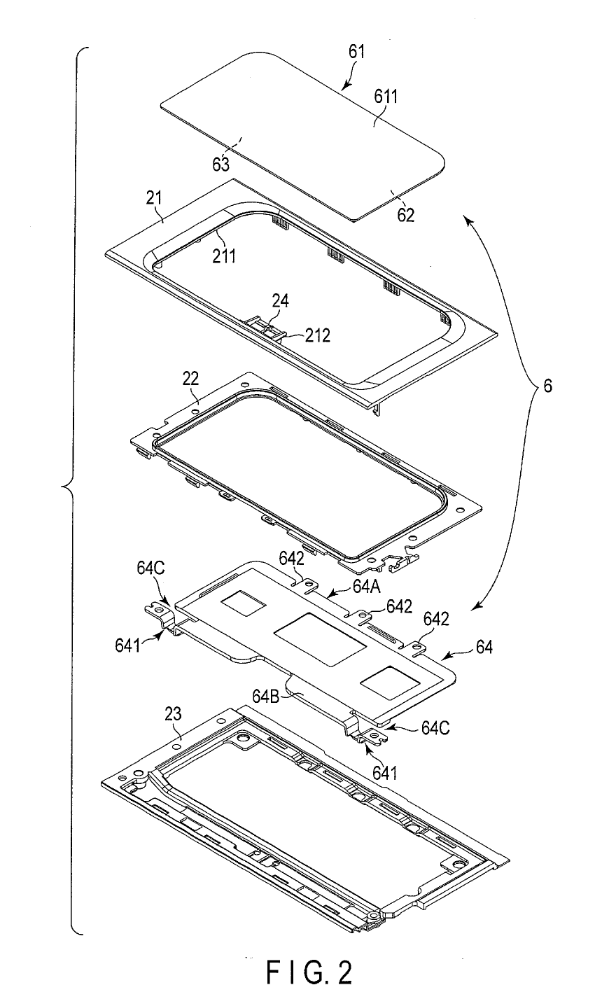

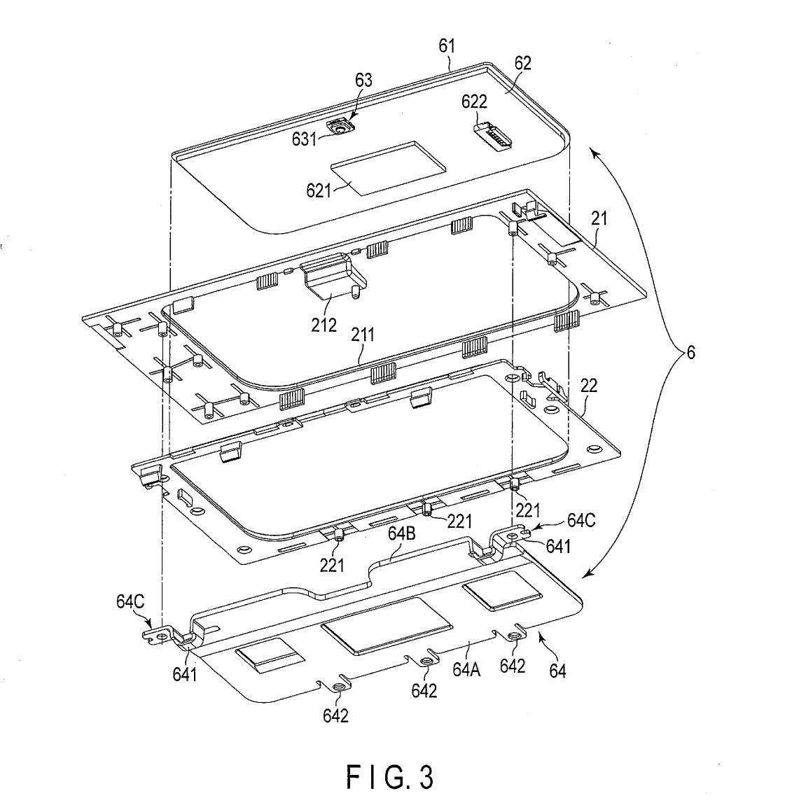

The touch pad 6 which is an example of the input apparatus has a pad 61, a circuit substrate 62, a switch 63 and a support 64 as illustrated in FIGS. 2 and 3. The touch pad 6 is exposed in an opening portion 211 of a design panel 21 which forms the outer shell of the housing 2. A frame 22 is attached to an inner surface side of the design panel 21 to reinforce the opening portion 211. A member illustrated at the lowermost part in FIG. 2 is part of the housing 2, and is part of a middle frame 23 which supports the keyboard 5 in the present embodiment. Together with the keyboard 5, the touch pad 6 is arranged on the middle frame 23.

An input unit 611 is formed on a obverse of the pad 61 as illustrated in FIGS. 2, 5 and 6. The touch pad 6 specifies an input position on the input unit 611 according to a change in electrostatic capacitance. As illustrated in FIGS. 3, 5 and 6, the circuit substrate 62 is attached to the reverse of the pad 61, and controls a signal inputted from the pad, that is, performs control of detecting a position or an area touched on the pad 61 and outputting an operation performed with respect to the pad 61 based on information about this position or area.

As illustrated in FIGS. 3, 5 and 6, the switch 63 is mounted on the reverse side of the pad 61, that is, on the rear surface of the circuit substrate 62 together with other electronic part 621 and connector 622 in the present embodiment. The switch 63 is mounted on the circuit substrate 62, so that a wiring for the switch 63 does not need to be separately provided. Further, the switch 63 is arranged on the reverse of the pad 61, so that failure due to intruding dust hardly occurs. This switch 63 is a push-button type, and adopts a mechanism which notifies that an operation is accepted by emitting sound or causing vibration when the switch 63 is pushed by a force equal to or more than a certain load such that the user can perceive the acceptance of the operation when making the operation, that is, a mechanism which can provide a so-called “sense of clicking”. The mechanism for providing this sense of clicking may be provided separately from the switch 63.

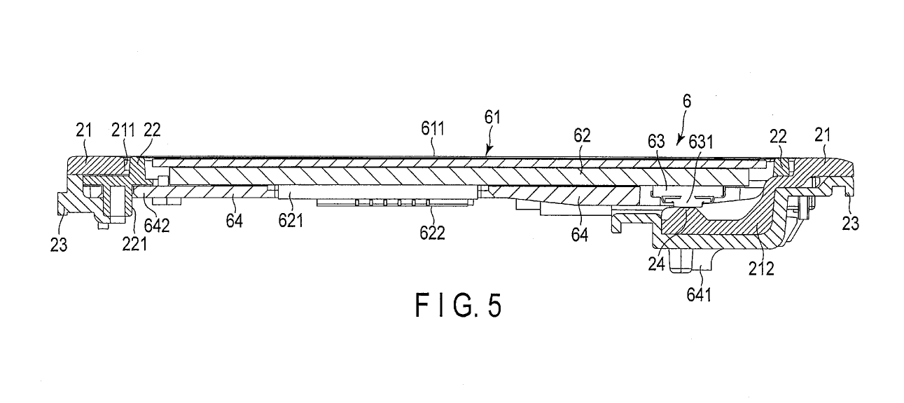

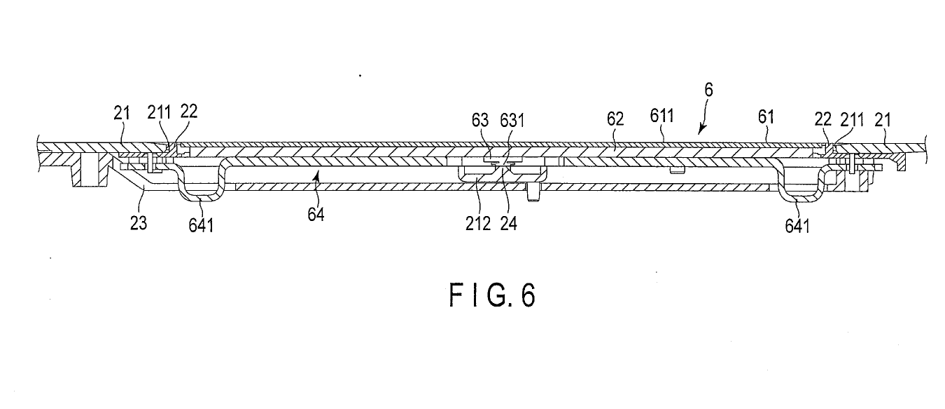

The support 64 holds from below the pad 61 to which the circuit substrate 62 is attached as illustrated in FIGS. 2 and 5, and is jointed to the housing 2 by arms 641 integrally molded in part of the support 64 as illustrated in FIGS. 3 and 6. In the present embodiment, distal portions of the arms 641 are inserted between the design panel 21 to which the frame 22 is attached from below, and the middle frame 23. The arms 641 have spring elasticity which displaces this pad 61 in the thickness direction of the pad 61. In the present embodiment, the arms 641 have arch shapes like horseshoe shapes which are curved in a direction in which the pad 61 is displaced as illustrated in FIG. 6, that is, so-called “corrugated shapes”. Further, the distal portions of the arms 641 connected to the housing 2 are positioned outside an operation area of the pad 61. Consequently, it is possible to set a greater stroke for displacing the pad 61 such that the arms 641 do not interfere with the pad 61 and the circuit substrate 62. Further, the arms 641 are integrally molded with the support 64. A material of the support 64 which includes the arms 641 may be not only synthetic resin which is made by injection molding but also a metal leaf spring made by punching by press working. A smaller number of parts are required compared to an apparatus which is separately provided with an elastic member, an assembly work becomes simple and managing assembly tolerance also becomes easy.

Further, a rim 64A of the support 64 facing the center of the housing 2, that is, a rear rim adjacent to the keyboard 5, is supported to tilt with respect to the housing 2. In the present embodiment, the support 64 has tabs 642 which freely fits to bosses 221 formed in the frame 22 as illustrated in FIG. 3. These tabs 642 are inserted between the frame 22 and the middle frame 23 as illustrated in FIG. 6. As illustrated in FIGS. 3 and 6, the switch 63 and the arms 641 are arranged along a front rim 64B which is a turning tip when the tabs 642 are turning bases. A pair of arms 641 is arranged at both end portions of the front rim, that is, at corners 64C on the front side. The switch 63 is arranged in substantially the center of a pair of arms 641.

When the touch pad 6 is pushed, a base 24 which receives a button 631 of the switch 63 is arranged in a bracket 212 extending from the rim of the opening portion 211 of the design panel 21 to an inside as illustrated in FIG. 2. The bracket is supported by the middle frame 23 as illustrated in FIGS. 5 and 6.

The touch pad 6 formed as described above detects a position of the pad 61 which the user touches or an operation, and, the switch 63 outputs a signal while giving the sense of clicking to the user by means of vibration or sound when the pad 61 is pushed. Consequently, the touch pad 6 according to the present embodiment is also referred to as the “touch-click pad”.

The touch pad 6 according to the present embodiment has one switch 63 which gives the sense of clicking by causing vibration or emitting sound when operated, in the center in the width direction of the operation area of the pad 61, and the circuit substrate 62 outputs a different signal according to the operation position of the pad 61 when the switch 63 activates. That is, even one switch 63 can exert the same function corresponding to a plurality of switches by being combined with position information inputted from the pad 61.

In the present embodiment, a function corresponding to operation buttons of a mouse is allocated to an area of the top surface of the pad 61 closer to the user. That is, a function of a so-called “left click (left button operation)” is allocated to a left half of the front side of the touch pad 6, and a function of a so-called “right click (right button operation)” is allocated to the right half of the front side. An example of an operating method will be described. The user first moves and adjusts a cursor position to a desired position using the entire surface of the pad 61, and pushes a portion close to the right or a portion close to the left of the front side of the pad 61 to an extent that the user can perceive that the operation is performed based on vibration or sound caused or emitted by the mechanism built in the switch 63, that is, to an extent that the user can have the sense of clicking. By so doing, it is possible to execute the same operation as the mouse operation using the touch pad 6. To distinguish areas corresponding to a right button operation and a left button operation, a convex strip or a groove indicating a boundary between the areas is formed in the obverse of the pad 61 or surface finishing which gives a different texture may be applied to the obverse of the pad 61.

The portable computer 1 which has the touch pad 6 formed as described above requires a small total number of parts which form the touch pad 6 and also requires a small number of parts stacked in the thickness direction. The number of parts is small, so that assembling the parts and managing assembly tolerance are easy. Further, the support 64 which displaceably holds the pad is jointed with the housing 2 by the arms 641 which have spring elasticity. The configuration is simple, so that the operability is good and durability is good.

In addition, the touch pad 6 has been described as an example of the input apparatus in the above embodiment. The technique according to the above embodiment can have a function corresponding to a plurality of switches which can provide the sense of clicking and, consequently, is also applicable even to a keyboard which is an example of the input apparatus operated by the user. In this case, by independently providing keys which are simultaneously pushed and integrating a plurality of keys which are not pushed simultaneously, it is possible to reduce the number of switches which are required. Further, a function as the touch pad is added to the keyboard.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a housing for an outer shell; and
an input apparatus comprising an input unit exposed to an outside of the housing to be operated, wherein the input apparatus comprises:
a pad comprising the input unit on an obverse;
a circuit substrate attached to a reverse of the pad and configured to control a signal inputted from the pad;
a switch fastened to a reverse side of the pad; and
a support configured to hold the pad, and to be jointed to the housing by an arm which comprises spring elasticity which displaces the pad in a thickness direction.

2. The electronic apparatus of claim 1, wherein
the arm is curved in a direction in which the pad is displaced.

3. The electronic apparatus of claim 1, wherein
the arm is connected to the housing on an outer side of an operation area of the pad.

4. The electronic apparatus of claim 1, wherein
the pair of arms are provided with the switch arranged in a center.

5. The electronic apparatus of claim 1, wherein:
the support comprises a rim facing a center of the housing, and is rotatably supported to the housing; and
the switch and the arm are arranged at a turning tip side apart from the rim.

6. The electronic apparatus of claim 1, wherein
the switch is mounted on the circuit substrate.

7. The electronic apparatus of claim 1, wherein:
the switch is arranged in a center in a width direction of an operation area of the pad; and
the circuit substrate outputs a different signal according to an operation position of the pad when the switch activates.

8. The electronic apparatus of claim 1, wherein
the switch comprising a mechanism which notifies that an operation is accepted by emitting sound or causing vibration when the switch is pushed by a force equal to or more than a certain load.
